(19) United States
(12) Patent Application Publication
(10) Pub. No.: US 2018/0099666 A1
(43) Pub. Date: Apr. 12, 2018

(54) VEHICLE CONTROL DEVICE

(71) Applicant: HONDA MOTOR CO., LTD, Tokyo (JP)

(72) Inventors: Chihiro Abe, Wako-shi (JP); Daichi Kato, Wako-shi (JP)

(21) Appl. No.: 15/726,494

(22) Filed: Oct. 6, 2017

(30) Foreign Application Priority Data
Oct. 12, 2016 (JP) 2016-200797

(51) Int. Cl. B60W 30/12; B60W 40/072; B60W 10/20

(52) U.S. Cl. CPC B60W 30/12; B60W 40/072; B60W 2550/22; B60W 2550/146; B60W 10/20

(57) ABSTRACT

A vehicle control device is installed in a host vehicle and is equipped with external environment sensors that detect the surrounding environment of the host vehicle, and a map generating unit which generates a center line CL of a travel path on which the host vehicle travels, based on detection information detected by the external environment sensors. The map generating unit includes a determination unit, which determines whether a curvature of a provisional center line PCL or a change in the curvature is greater than a predetermined value. When the curvature or the change in the curvature is greater than the predetermined value, the curvature of the provisional center line PCL is corrected by a correction unit to be less than or equal to the predetermined value, and a center line CL is established.

### CROSS-REFERENCE TO RELATED APPLICATION

This application is based upon and claims the benefit of priority from Japanese Patent Application No. 2016-200797 filed on Oct. 12, 2016, the contents of which are incorporated herein by reference.

### BACKGROUND OF THE INVENTION

### Field of the Invention

The present invention relates to a vehicle control device which performs automatic driving or provides a driving assist for a vehicle.

### Description of the Related Art

In a vehicle control device that performs automatic driving or provides a driving assist for a vehicle (a user's own vehicle, also referred to herein as a “host vehicle”), the surrounding environment of the host vehicle is detected by peripheral recognition sensors (external environment sensors) such as cameras or the like, and on the basis of the information detected thereby, a travel path on which the host vehicle travels is recognized (See Japanese Laid-Open Patent Publication No. 2016-112911). Additionally, the vehicle control device disclosed in Japanese Laid-Open Patent Publication No. 2016-112911 calculates a center line of the recognized travel path, and performs a control so that the host vehicle travels along the center line.

However, depending on the traveling state of the host vehicle and road conditions, the external environment sensors may not be capable of accurately detecting objects that regulate the travel path such as lane markings or the like. For example, in cases where the distance from the host vehicle to the travel path regulating objects is long, if the travel path regulating objects cannot be viewed completely, or if noise is contained within the detection information, there is a concern that the vehicle control device may calculate a center line (travel path shape) that changes sharply to such a degree that the traveling behavior of the host vehicle cannot cope with it. One example is a case in which the curvature of a curve (travel path shape) is large, and the host vehicle is incapable of turning along such a curvature. Provisionally, if the vehicle control device were to perform a process so as to match with the center line, there is a possibility that the control content may undergo an abrupt change in such a manner that, for example, a control stoppage will occur.

### SUMMARY OF THE INVENTION

The present invention has been devised in view of the aforementioned circumstances, and an object of the present invention is to provide a vehicle control device that is capable of suitably controlling a host vehicle by appropriately correcting the shape of a travel path, in the case that the travel path shape which was generated on the basis of recognizing the surrounding environment does not match with the traveling behavior of the host vehicle.

In order to achieve the above-described object, the present invention is characterized by a vehicle control device which is installed in a host vehicle and configured to be capable of implementing automatic driving or providing a driving assist, comprising an external environment sensor adapted to detect a surrounding environment of the host vehicle, and a map generating unit adapted to generate a travel path shape of a travel path on which the host vehicle travels, on the basis of detection information detected by the external environment sensor. The map generating unit includes a determination unit adapted to determine whether or not a curvature of the travel path shape or a change in the curvature is greater than a predetermined value, and a correction unit adapted to correct the curvature of the travel path to be less than or equal to the predetermined value, in the event it is determined by the determination unit that the curvature of the travel path shape or the change in the curvature is greater than the predetermined value.

According to the features of the invention noted above, the vehicle control device can suitably control the host vehicle by the map generating unit correcting the curvature of the travel path shape, in the case that the curvature of the travel path or the change in the curvature is significantly large. More specifically, by means of the correction, the curvature of the travel path shape, which was generated based on detection of the surrounding environment, is set to be less than or equal to a predetermined curvature (to match the traveling behavior of the host vehicle), and therefore, the map generating unit is capable of providing a travel path shape that suppresses a sudden change in the control content such as stopping the control of the host vehicle or the like. Consequently, the vehicle control device can continue the control of the host vehicle based on the travel path shape.

In this case, the correction unit preferably corrects the travel path shape into an arcuate route corresponding to a turning ability of the host vehicle.

By the vehicle control device setting the travel path shape to an arcuate shape that corresponds to the turning ability of the host vehicle, it is possible to control the host vehicle so as to follow the travel path shape.

Further, in the correction of the travel path shape, the correction unit may cause a tangent line of a predetermined point of the arcuate route to be continuous with the arcuate route.

In the vehicle control device, by making the linear tangent line continuous with the arcuate route, it is possible to allow the host vehicle to travel while avoiding turning in such a manner that the host vehicle makes a U-turn.

In addition, in the above configuration, the determination unit may determine whether or not the curvature of the travel path shape in the vicinity of the host vehicle is greater than a vicinity threshold value which serves as a limit value of the turning ability of the host vehicle.

By the determination unit determining the curvature of the travel path shape in the vicinity of the host vehicle, the vehicle control device is capable of controlling the vehicle so as to travel immediately along the corrected travel path shape.

In this instance, the vicinity of the host vehicle lies within a range extending from a current position to a vehicle length of the host vehicle or less.

Since the vicinity of the host vehicle lies within the range of the vehicle length or less, in the case that the travel path shape is corrected, the vehicle control device can form a route in which turning of the host vehicle can be executed in a stable manner.

Alternatively, the correction unit may linearly correct the travel path shape of a location where the change in the curvature is large.

In the case that the curvature of the travel path shape is not changing in a continuous manner, it can be noted that generation of the travel path shape on the basis of detections made by external environment sensors is not performed with high accuracy. Therefore, by linearly correcting the travel path shape at the location where the change in curvature is significantly large, it is possible for the vehicle control device to continue the control of the host vehicle more reliably.

In addition, in the above configuration, the determination unit may determine whether or not the change in the curvature of the travel path shape, which is more distant than the vicinity of the host vehicle, is greater than a separation threshold value.

By the determination unit determining a change in the curvature of the travel path shape that is more distant than the vicinity of the host vehicle, even if detection of the travel path by the external environment sensors is unclear, the vehicle control device can follow the shape along the travel path shape based on another detection result.

Furthermore, the determination unit, together with determining the change in the curvature of the travel path shape, may also determine a degree of reliability of the detection information, and in the case that the degree of reliability is less than or equal to a predetermined value, correction of the travel path shape preferably is performed by the correction unit, whereas in the case that the degree of reliability is greater than the predetermined value, correction of the travel path shape preferably is not performed by the correction unit.

If the degree of reliability is low, it can be understood that the travel path shape is incorrect, and therefore, by correcting the travel path shape, the vehicle control device can continue the control in a satisfactory manner. On the other hand, if the degree of reliability is high, it can be understood that the travel path shape is accurate, and therefore, by not carrying out correction of the travel path shape even if the curvature changes greatly, the vehicle control device can perform a control that is suitable for the actual travel path.

In addition, the map generating unit may include an event setting unit adapted to set event information that changes a vehicle velocity of the host vehicle, which is extracted from map information and/or the detection information, on the generated or corrected travel path shape.

Due to the event information being set on the travel path shape by the event setting unit, the vehicle control device can easily implement a control corresponding to the event information when the host vehicle travels on the travel path.

Further, the travel path shape contains information of a sequence of points in which a plurality of coordinate points are arranged, and the event setting unit preferably sets a coordinate point of the event information among the plurality of coordinate points, in the event that a position of the extracted event information is located among the plurality of coordinate points.

By setting the coordinate point of the event information among the plurality of coordinate points, the vehicle control device can correctly reflect the position of the event information on the travel path shape. Accordingly, for example, in the case of event information for which the host vehicle is to stop, the host vehicle can be made to stop accurately at the position of the event information.

Still further, the travel path shape may be calculated as a center line of the travel path.

Since the center line of the travel path can be regarded as reflecting the state of the travel path in its entirety, by performing various processes using such a center line, the vehicle control device can enhance both processing efficiency and accuracy of the control.

According to the present invention, it is possible to suitably control the host vehicle by appropriately correcting the shape of a travel path, in the case that the travel path shape which was generated on the basis of recognizing the surrounding environment does not match with the traveling behavior of the host vehicle.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing schematically the configuration of a vehicle control device according to an embodiment of the present invention;

FIG. 2 is a block diagram showing the configuration of a local environment map generating unit shown in FIG. 1;

FIG. 3 is an explanatory diagram for explaining a process of a provisional center line generating unit for calculating a provisional center line;

FIG. 4 is a plan view for describing a first situation in which a center line correction unit performs a center line correction;

FIG. 5 is a plan view for describing a second situation in which the center line correction unit performs a center line correction;

FIG. 6A is an explanatory view showing an example of setting a plurality of event information along a center line;

FIG. 6B is an explanatory diagram showing an example of setting a coordinate point of the event information between a plurality of coordinate points; and

FIG. 7 is a flowchart showing the process flow of a local environment map generating unit.

### DESCRIPTION OF THE PREFERRED EMBODIMENTS

A preferred embodiment of a vehicle control device according to the present invention will be presented and described in detail below with reference to the accompanying drawings.

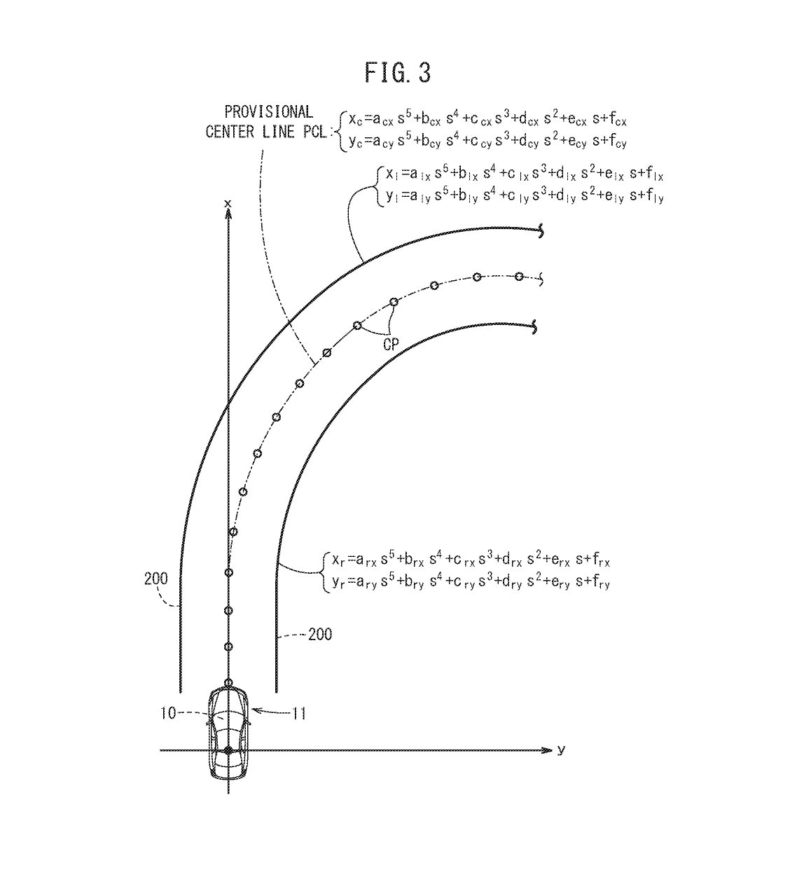

The vehicle control device 10 according to one embodiment of the present invention is installed in a vehicle 11 (hereinafter also referred to as a host vehicle 11, see also FIG. 3) and controls automatic driving of the host vehicle 11. In such automatic driving, a speed control (acceleration, deceleration, speed maintenance, etc.) for adjusting the vehicle velocity of the host vehicle 11, and a steering angle control for adjusting the direction of travel of the host vehicle 11 are performed in an integral manner. Further, at this time, the vehicle control device 10 recognizes the surrounding environment of the host vehicle 11 including a travel path, and causes the host vehicle 11 to travel along an appropriate route on the travel path.

In particular, accompanying recognition of the surrounding environment around the host vehicle 11, the vehicle control device 10 generates a provisional center line PCL of the travel path, and is configured so as to carry out an appropriate process by determining such a provisional center line PCL. In accordance with these features, the vehicle control device 10 calculates a center line CL that is capable of being used more suitably for the control, and by using the center line CL to generate a trajectory for the host vehicle 11 (information to instruct the velocity and steering angle of the host vehicle 11), it is possible to cause the host vehicle 11 to travel suitably along such a trajectory. The vehicle control device 10 will be described in detail below.

### [Overall Configuration of the Host Vehicle 11]

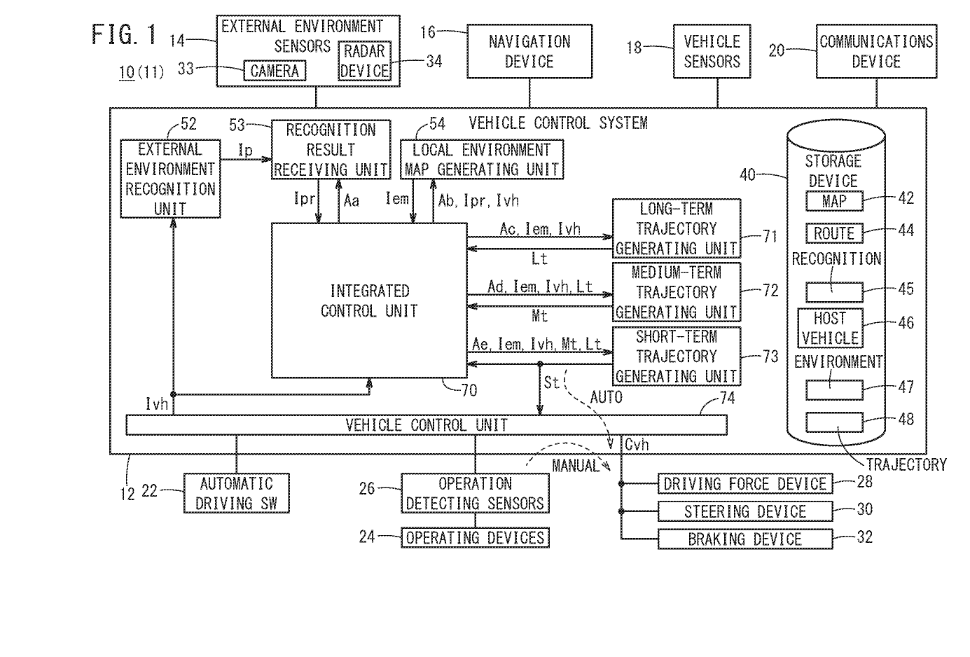

As shown in FIG. 1, the vehicle control device 10 includes a vehicle control system 12 (electronic control unit) which makes up a principal component of a system that carries out processes during traveling of the host vehicle 11, and is further equipped with input devices and output devices that are connected via communication lines to the vehicle control system 12. The input devices include external environment sensors 14, a navigation device 16, vehicle sensors 18, a communications device 20, an automatic driving switch 22 (automatic driving SW), and operation detecting sensors 26, etc. The output devices include a driving force device 28, a steering device 30, and a braking device 32, etc.

The external environment sensors 14 are a group of sensor devices that recognize the situation outside of the host vehicle 11, and according to the present embodiment, are constituted by one or more cameras 33 and one or more radar devices 34. The camera 33 and the radar device 34 detect the external environment in accordance with respective characteristics thereof, and output detection information to the vehicle control system 12. Moreover, the external environment sensors 14 may be constituted by one type of device, or other devices may be applied thereto. Examples of such other devices include an infrared sensor, an ultrasonic sensor, and a LIDAR (light detection and ranging) device.

The navigation device 16 detects and specifies a current position of the host vehicle 11 using a satellite positioning device or the like, and further calculates a route from the current position to a destination point designated by the user. Information of the navigation device 16 (map information, the current position, the calculated route, etc.) is supplied to the vehicle control system 12 as required, and is stored in the map information storage unit 42 and a route information storage unit 44 of a storage device 40.

The vehicle sensors 18 are a sensor device group (vehicle state detection unit) that detects the state of the host vehicle 11, and outputs the detected result thereof to the vehicle control system 12 during traveling of the host vehicle 11 or the like. As members of the sensor device group, there may be cited a vehicle velocity sensor for detecting the vehicle velocity, and an acceleration sensor for detecting the acceleration of the host vehicle 11, a yaw rate sensor for detecting the angular velocity about a vertical axis of the host vehicle 11, an orientation sensor for detecting an orientation of the host vehicle 11, and a gradient sensor for detecting a gradient of the host vehicle 11, etc. Detection information detected by the vehicle sensors 18 (or a vehicle control unit 74) is stored as vehicle state information Ivh of the host vehicle in a host vehicle state information storage unit 46 of the storage device 40.

The communications device 20 is provided for the purpose of communicating with external communication devices (roadside devices, other vehicles, a server, etc.) that exist outside of the host vehicle 11. For example, the communications device 20 receives information (position and light colors) concerned with traffic signals from the roadside devices, probe information concerned with other vehicles from the other vehicles, and updated map information or other information from the server, and further, transmits probe information and the like of the host vehicle 11 to the exterior.

The automatic driving switch 22 is a switch to enable the driver to switch between a manual driving mode and an automatic driving mode. In the manual driving mode, the driver operates the operating devices 24 of the host vehicle 11, and thereby operates the output devices (the driving force device 28, the steering device 30, and the braking device 32) to cause the host vehicle 11 to travel or the like.

As the operating devices 24, there may be cited an accelerator pedal, a steering wheel (handle), a brake pedal, a shift lever, and a direction indicating (turn signal) lever. Further, the operation detecting sensors 26, which detect the presence or absence or the operated amounts of operations made by the driver, as well as operated positions, are attached to the respective structures of the operating devices 24. The operation detecting sensors 26 output to the vehicle control system 12 as detection results an amount by which the accelerator is depressed (degree of accelerator opening), an amount (steering amount) at which the steering wheel is operated, an amount by which the brake pedal is depressed, a shift position, and a right or left turn direction, etc.

In the automatic driving mode, the host vehicle 11 is made to travel or the like under the control of the vehicle control device 10, in a state in which the driver does not operate the operating devices 24. During execution of the automatic driving mode, and on the basis of the surrounding environment of the host vehicle 11, the vehicle control system 12 generates action plans (long-term trajectories, medium-term trajectories, short-term trajectories, to be described later) and appropriately controls the output devices (the driving force device 28, the steering device 30, the braking device 32) in accordance with the action plans.

The driving force device 28 includes a non-illustrated driving force ECU, and a drive source such as an engine and a drive motor or the like. The driving force device 28 generates a travel driving force (torque) in accordance with vehicle control values Cvh input thereto from the vehicle control system 12, and transmits the travel driving force to the vehicle wheels directly or through a transmission.

The steering device 30 includes a non-illustrated EPS (electric power steering) ECU, and an EPS device. The steering device 30 changes the orientation of the wheels (steered wheels) in accordance with vehicle control values Cvh input thereto from the vehicle control system 12.

The braking device 32, for example, is an electric servo brake used in combination with a hydraulic brake, and includes a non-illustrated brake ECU and a brake actuator. The braking device 32 brakes the vehicle wheels in accordance with vehicle control values Cvh input thereto from the vehicle control system 12.

### [Configuration of Vehicle Control System 12]

The vehicle control system 12 is constituted as an electronic control unit (ECU) equipped with a non-illustrated processor and an input/output interface, and the storage device 40 as hardware components, and further, is constructed with a plurality of function realizing units therein. More specifically, the function realizing units include an external environment recognition unit 52, a recognition result receiving unit 53, a local environment map generating unit 54, an integrated control unit 70 (task synchronization module), a long-term trajectory generating unit 71, a medium-term trajectory generating unit 72, a short-term trajectory generating unit 73, and a vehicle control unit 74. In the present embodiment, the function realizing units are software-based functional units, in which the functions thereof are realized by a processor executing programs stored in the storage device 40. However, the functions thereof can also be realized by hardware-based functional units constituted from integrated circuits or the like.

The external environment recognition unit 52 utilizes the various detection information input from the external environment sensors 14, the navigation device 16, the communications device 20, and the like, and generates information (hereinafter referred to as external environment recognition results Ip) of the results of having extracted objects existing outside the host vehicle 11. When the external recognition results Ip are generated, reference is made to the detected results of the radar devices 34, etc., as well as the host vehicle state information Ivh transmitted from the vehicle sensors 18 and the vehicle control unit 74, and a relative positional relationship of objects with respect to the host vehicle 11 (a direction and distance of such objects with respect to the host vehicle 11) is also recognized. At this time, the external environment recognition unit 52 may recognize the relative positional relationship by arranging the extracted objects on a two-dimensional plane (host vehicle coordinate system) with the host vehicle 11 acting as a reference.

For example, on the basis of image information from the cameras 33, the external environment recognition unit 52 extracts lane markings (white lines, yellow lines, markers, etc.), guardrails, curbstones, stop lines, traffic lights (traffic signal stop lines), and other objects such as signs, obstacles, traffic participants, etc., of a road on which the host vehicle 11 travels. In this instance, features that define a travel capable range of the travel path, such as lane markings, guardrails, curbstones, and the like, can be regarded as static information in which no changes occur within a short time period. Hereinafter, such features are referred to collectively as travel path regulating objects 200 (for the sake of convenience, such features are indicated as detection results by dotted lines on the left and right boundary lines in FIG. 3). On the other hand, obstacles and traffic participants can be regarded as dynamic information in which changes occur therein within a short time period.

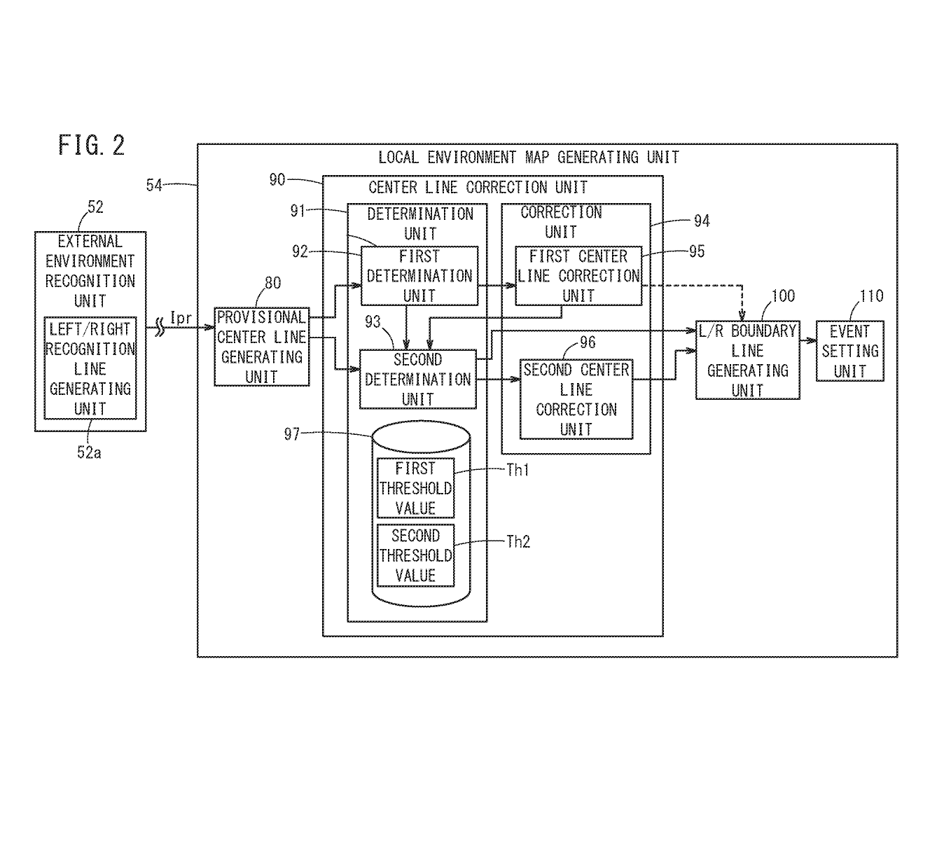

As shown in FIG. 2, in the interior of the external environment recognition unit 52, a left/right recognition line generating unit 52a is provided, which based on recognizing the travel path regulating objects 200, generates a left recognition line (x₁, y₁) and a right recognition line (xᵣ, yᵣ) as recognition information indicative of left and right travel capable ranges. The left and right recognition lines are constituted as a sequence of points in which a plurality of coordinate points CP are arranged on the host vehicle coordinate system. Upon processing the detection information, and extracting the left and right travel path regulating objects 200 of the travel path on which the host vehicle 11 travels, the left/right recognition line generating unit 52a performs a polynomial approximation on the travel path regulating objects 200, and thereby generates the left and right recognition lines.

For example, as shown in FIG. 3, in the polynomial approximation of the host vehicle coordinate system, the left recognition line (x₁, y₁) and the right recognition line (xᵣ, yᵣ) of the host vehicle 11 are expressed by the following equations (1) to (4).

### Left Recognition Line:

x₁=a₁ₓs⁵+b₁ₓs⁴+c₁ₓs³+d₁ₓs²+e₁ₓs+f₁ₓ (1)

y₁=a_{1y}s⁵+b_{1y}s⁴+c_{1y}s³+d_{1y}s²+e_{1y}s+f₁y (2)

Right Recognition line:

xᵣ=aᵣₓs⁵+bᵣₓs⁴+cᵣₓs³+dᵣₓs²+eᵣₓs+fᵣₓ (3)

yᵣ=a_{ry}s⁵+b_{ry}s⁴+c_{ry}s³+d_{ry}s²+e_{ry}s+f_{ry} (4)

In this instance, for example, s represents a distance from the current position P0 of the host vehicle 11. The origin point (s=0) may be set arbitrarily.

Even if actual lane markings, guardrails, curbstones and the like on the travel path are lost by performing a polynomial approximation such as that of expressions (1) to (4), it is possible to calculate such features as supplemental lines. Moreover, in equations (1) to (4) above, the left and right recognition lines are approximated by fifth order functions of the distance s, however, a polynomial approximation of a different order may be carried out. Further, the left and right recognition lines may be generated by the local environment map generating unit 54.

Returning to FIG. 1, the recognition result receiving unit 53 periodically receives the external environment recognition results Ip (including the left and right recognition lines) recognized by the external environment recognition unit 52, and updates any old information. In addition, at a timing at which a calculation command Aa is received from the integrated control unit 70, the recognition result receiving unit 53 transmits to the integrated control unit 70 the external environment recognition results Ip as external environment recognition information Ipr. Such external environment recognition information Ipr is stored in an external environment recognition information storage unit 45 of the storage device 40 as individual or integrated information of each of the objects extracted from the external recognition results Ip.

Based on the external environment recognition information Ipr and the host vehicle state information Ivh, the local environment map generating unit 54 calculates a route along which the host vehicle 11 travels, and generates local environment map information Iem. The local environment map generating unit 54 receives, at an appropriate timing from the integrated control unit 70, a calculation command Ab, the external environment recognition information Ipr, and the host vehicle state information Ivh, and performs calculations in order to obtain the local environment map information Iem. The local environment map information Iem is stored in a local environment map information storage unit 47 of the storage device 40. The specific configuration of the local environment map generating unit 54 will be described in detail later.

The integrated control unit 70, together with synchronizing the tasks (processing operations) of the recognition result receiving unit 53, the local environment map generating unit 54, the long-term trajectory generating unit 71, the medium-term trajectory generating unit 72, and the short-term trajectory generating unit 73, provides information necessary for calculations to the respective function realizing units. The integrated control unit 70 internally counts a standard calculation cycle, and outputs operation commands to each of the function realizing units in accordance with a timing based on the standard calculation cycle, to thereby execute the processes and receive the processing results thereof.

On the other hand, under commands from the integrated control unit 70, the long-term trajectory generating unit 71, the medium-term trajectory generating unit 72, and the short-term trajectory generating unit 73 generate trajectories, respectively, including vehicle velocities necessary for controlling the velocity of the host vehicle 11, and routes necessary for controlling the steering of the host vehicle 11. The long-term trajectory generating unit 71 generates a long-term trajectory Lt, which is a trajectory having a somewhat long period (for example, ten seconds) during traveling of the host vehicle 11. The medium-term trajectory generating unit 72 generates a medium-term trajectory Mt, which is a trajectory having a period that is shorter than the long-term trajectory Lt (for example, five seconds). The short-term trajectory generating unit 73 generates a short-term trajectory St, which is a trajectory having a period that is shorter than the medium-term trajectory Mt (for example, one second).

More specifically, the long-term trajectory generating unit 71 generates the long-term trajectory Lt on the basis of a calculation command Ac output from the integrated control unit 70, the local environment map information Iem, and the host vehicle state information Ivh, etc. The long-term trajectory Lt is a sequence of points indicating long-term travel targets in consideration of riding comfort (abrupt steering and abrupt acceleration/deceleration, etc., are not carried out), primarily on the basis of left and right boundary line information, center line information, and ideal route information of the location environment map information Iem. The long-term trajectory Lt is calculated in the form of information obtained by arranging a plurality of coordinate points whose timewise distance is relatively longer than that of the medium-term trajectory Mt.

For example, the long-term trajectory generating unit 71 generates the long-term trajectory Lt in which coordinate points thereof including time or velocity information are arranged in a time period of ten seconds and at intervals on the order of several hundreds of ms (nine times the standard calculation period), and then outputs the generated long-term trajectory Lt to the integrated control unit 70. The long-term trajectory Lt is stored in a trajectory information storage unit 48 of the storage device 40. The medium-term trajectory generating unit 72 generates the medium-term trajectory Mt on the basis of a calculation command Ad output from the integrated control unit 70, the local environment map information Iem, the host vehicle state information Ivh, and the long-term trajectory Lt. The medium-term trajectory Mt is calculated as a sequence of points taking into account the dynamic information included in the local environment map information Iem, in order to indicate travel targets which are capable of coping with situations of a few seconds ahead in the vicinity of the host vehicle 11. For example, in the case that the external environment recognition unit 52 discovers a parked vehicle (dynamic information) located in front in the direction of travel of the host vehicle 11, then based on the medium-term trajectory Mt which is generated by the medium-term trajectory generating unit 72, and the short-term trajectory St which is generated by the short-term trajectory generating unit 73, the host vehicle 11 can avoid coming into contact with the parked vehicle.

For example, the medium-term trajectory generating unit 72 generates the medium-term trajectory Mt in which coordinate points thereof including time or velocity information are arranged in a time period of five seconds and at intervals on the order of one hundred and several tens of ms (three times the standard calculation period), and then outputs the medium-term trajectory Mt to the integrated control unit 70. The medium-term trajectory Mt is stored in the trajectory information storage unit 48 of the storage device 40.

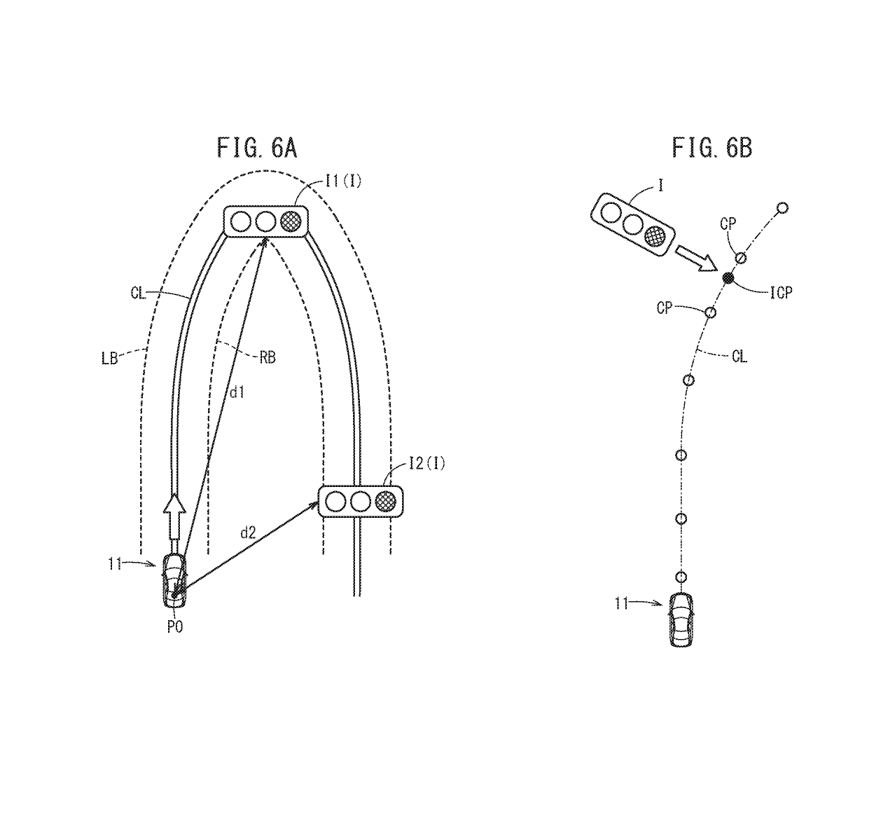

The short-term trajectory generating unit 73 generates the short-term trajectory St on the basis of a calculation command Ae output from the integrated control unit 70, the local environment map information Iem, the host vehicle state information Ivh, the long-term trajectory Lt, and the medium-term trajectory Mt. Since it is calculated as a sequence of points having a shortest timewise distance therebetween, the short-term trajectory St corresponds with the vehicle dynamics of the host vehicle 11. Therefore, at each of the individual coordinate points that make up the short-term trajectory St, there are included such features as a position x in the longitudinal direction lying substantially along the center line CL of the lane markings (see FIG. 6A), a position y in the lateral direction, a posture angle θz, a velocity vs, an acceleration va, and a steering angle δst, etc.

For example, the short-term trajectory generating unit 73 generates the short-term trajectory St by calculating coordinate points including the information of the above-described vehicle dynamics in a time period of one second and at intervals on the order of several ms (the standard calculation period). The short-term trajectory St is transmitted directly to the vehicle control unit 74, and is used by the vehicle control unit 74 in carrying out the travel control of the host vehicle 11. Further, the short-term trajectory generating unit 73 also outputs the generated short-term trajectory St to the integrated control unit 70. The short-term trajectory St is stored in the trajectory information storage unit 48 of the storage device 40.

On the other hand, so that the host vehicle 11 travels along the input short-term trajectory St, the vehicle control unit 74 converts the coordinate points including the vehicle dynamics into vehicle control values Cvh, and outputs the vehicle control values Cvh to the driving force device 28, the steering device 30, and the braking device 32. Further, information for driving the driving force device 28, the steering device 30, and the braking device 32 is transmitted as host vehicle state information Ivh to the external environment recognition unit 52.

### [Specific Configuration of Local Environment Map Generating Unit 54]

In addition, during traveling of the host vehicle 11, and on the basis of the external environment recognition results Ip (external environment recognition information Ipr) recognized by the external environment recognition unit 52, the local environment map generating unit 54 of the vehicle control device 10 according to the present embodiment calculates the center line CL as well as the left and right boundary lines LB, RB (see FIG. 6A). Furthermore, the local environment map generating unit 54 includes within the calculated center line CL and the left and right boundary lines LB, RB the event information such as stop positions or the like possessed by the external environment recognition information Ipr, and outputs the center line CL and the left and right boundary lines LB, RB as local environment map information Iem to the integrated control unit 70.

The center line CL and the left and right boundary lines LB, RB are generated as a sequence of points in which coordinate points CP thereof are arranged at predetermined intervals on the host vehicle coordinate system (on a two-dimensional plane) with the host vehicle 11 acting as a reference. Owing to this feature, it is possible to improve the processing efficiency of the long-term trajectory generating unit 71, the medium-term trajectory generating unit 72, and the short-term trajectory generating unit 73 that utilize the local environment map information Iem.

As shown in FIG. 2, a provisional center line generating unit 80, a center line correction unit 90, a left/right boundary line generating unit 100, and an event setting unit 110 are provided inside the local environment map generating unit 54. The provisional center line generating unit 80 calculates a provisional center line PCL of the travel path, the center line correction unit 90 determines the shape of the provisional center line PCL, and performs an appropriate correction in the event that correction is necessary, and finally, calculates the center line CL. Further, based on the center line CL, the left/right boundary line generating unit 100 calculates left and right boundary lines (a left boundary line LB, a right boundary line RB). The event setting unit 110 assigns event information to the center line CL.

In this instance, it may be noted that the center line CL of the travel path reflects the condition (shape, etc.) of the travel path in its entirety. Therefore, the vehicle control device 10 is capable of enhancing processing efficiency and control accuracy by carrying out various processes using the center line CL. The processing content of the respective functional units will be described below in detail.

Using the external environment recognition information Ipr, the provisional center line generating unit 80 generates a virtual center line (provisional center line PCL (x_{c}, y_{c})) of the detected travel path (see FIG. 3). As described above, in the external environment recognition information Ipr, there are included the left and right recognition lines represented by equations (1) to (4). Accordingly, since the provisional center line PCL is represented by intermediate positions of the equations (1) to (4) in the host vehicle coordinate system, the provisional center line PCL may be expressed by the following equations (5) and (6).

### Provisional Center Line:

x_{c}=a_{cx}s⁵+b_{cx}s⁴+c_{cx}s³+d_{cx}s²+e_{cx}s+f_{cx} (5)

y_{c}=a_{cy}s⁵+b_{cy}s⁴+c_{cy}s³+d_{cy}s²+e_{cy}s+f_{cy} (6)

where, in equations (5) and (6),

a_{cx}=a*(aₗₓ+aᵣₓ) a_{cy}=a*(a_{ly}+a_{ry})

b_{cx}=a*(bₗₓ+bᵣₓ) b_{cy}=a*(b_{ly}+b_{ry})

c_{cx}=a*(cₗₓ+cᵣₓ) c_{cy}=a*(c_{ly}+c_{ry})

d_{cx}−a*(dₗₓ+bᵣₓ) d_{cy}−a*(d_{ly}+d_{ry})

e_{cx}=a*(eₗₓ+eᵣₓ) e_{cy}=a*(e_{ly}+e_{ry})

f_{cx}=a*(fₗₓ+fᵣₓ) f_{cy}=a*(f_{ly}+f_{ry})

Moreover, a=0.5, on the assumption that the degree of reliability of the left and right recognition lines is substantially equivalent. Further, cases may also exist in which the degree of reliability differs mutually between the left and right recognition lines, due to factors such as lack of one of the lane markings. In such an instance, the degree of reliability of the left and right recognition lines may be represented by β₁ and βᵣ, respectively, and a coefficient of the provisional center line PCL may be calculated as β₁*aₗₓ+βᵣ*aᵣₓ (a representative case of a_{cx} is exemplified). In this case, the degree of reliability is a value satisfying the equation β₁+βᵣ=1 and the inequalities 0≤β₁ and βᵣ≤1. In addition, it is satisfactory to use the value 0.5 (β₁*fₗₓ+βᵣ*fᵣₓ), so that only the constant terms f_{cx} and f_{cy} of equations (5) and (6) become the midpoints of the left and right boundary lines.

Furthermore, when the provisional center line PCL is calculated, the provisional center line generating unit 80 calculates a plurality of coordinate points CP that lie along the provisional center line PCL. At this time, discrete coordinate points CP₁(x₁, y₁), CP₂(x₂, y₂), . . . , CPₙ(xₙ, yₙ) are obtained by setting the provisional center line PCL in increments of a constant distance s (for example, by substituting s=1, 2, . . . , n). In addition, after calculating the provisional center line PCL (the sequence of points made up of the coordinate points CP₁, CP₂, . . . , CPₙ), the provisional center line generating unit 80 outputs the provisional center line PCL to the center line correction unit 90.

Returning to FIG. 2, upon receiving the provisional center line PCL from the provisional center line generating unit 80, the center line correction unit 90 determines whether or not the center line CL may be output by a determination unit 91 as local environment map information Iem (more specifically, whether the shape of the provisional center line PCL is appropriate). In addition, in the case it is determined that the provisional center line PCL is not appropriate, a correction to the provisional center line PCL is performed by a correction unit 94. In particular, the center line correction unit 90 is configured to perform corrections corresponding to respective situations, when provisional center lines PCL exhibiting a first situation and a second situation, to be described later, are detected. For this reason, the center line correction unit 90 has constructed therein within the determination unit 91 a first determination unit 92 and a second determination unit 93, and further has constructed therein within the correction unit 94 a first center line correction unit 95 and a second center line correction unit 96.

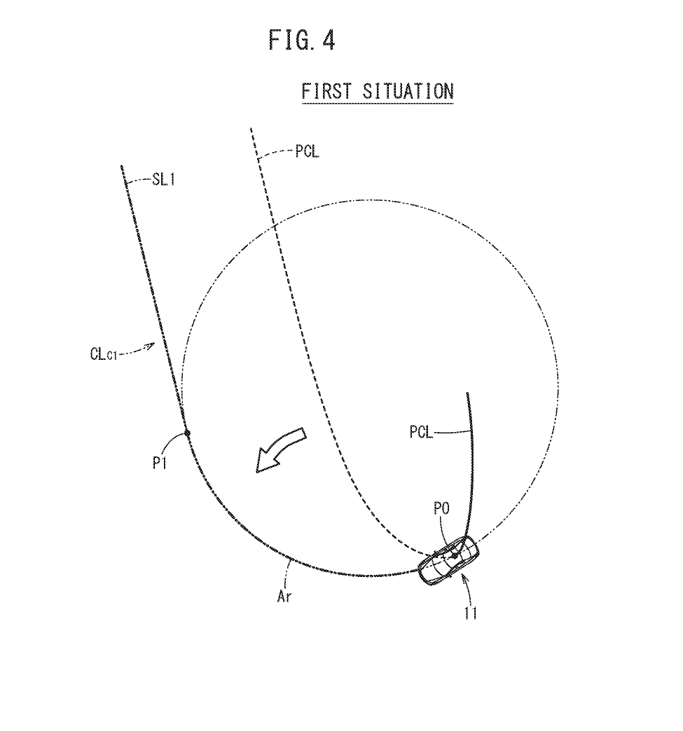

The first situation, as shown in FIG. 4, is a case in which a provisional center line PCL is generated by being rendered with a large curvature in the vicinity of the host vehicle 11 that is making a turn around a curve. More specifically, even if the vehicle control device 10 recognizes the center line CL (travel path shape) as having a large curvature in the vicinity of the host vehicle 11, the vehicle control device 10 cannot execute the turn because the turning ability of the host vehicle 11 does not adequately correspond to such a curvature. Alternatively, even if the host vehicle 11 is capable of making such a turn, a sudden change in course (a change in the control content) would have to be performed. Accordingly, in relation to the provisional center line PCL, the first determination unit 92 determines whether or not there is a large curvature in the vicinity of the host vehicle 11. In addition, if a large curvature is detected or determined to exist, the first center line correction unit 95 makes a correction to the provisional center line PCL.

More specifically, the first determination unit 92 stores in a threshold value storage unit 97 (a storage area of the storage device 40) a first threshold value Th1 (vicinity threshold value) of a curvature that corresponds to the turning ability of the host vehicle 11. The first threshold value Th1, for example, is indicative of a limit value of the turning ability of the host vehicle 11.

In addition, upon receiving the provisional center line PCL from the provisional center line generating unit 80, the first determination unit 92 reads out the first threshold value Th1, and determines whether or not, inside of a predetermined range (for example, 1 m) from the current position P0 of the host vehicle 11, the curvature of the provisional center line PCL is greater than the first threshold value Th1. The predetermined range, which defines the vicinity of the host vehicle 11, is not particularly limited, and may be, for example, a range from the current position P0 to a length in the longitudinal direction of the host vehicle 11 (vehicle length), and more preferably, may be predefined by a range of 0 m to 5 m. Further, the first determination unit 92 may perform a process such as acquiring the vehicle velocity, and expanding the predetermined range when the vehicle velocity is fast, and narrowing the predetermined range when the vehicle velocity is slow, or the like.

If the curvature of the provisional center line PCL in the vicinity of the host vehicle 11 is less than or equal to the first threshold value Th1, since there is no problem even if the host vehicle 11 turns along such a curvature, no correction to the provisional center line PCL is considered necessary. Conversely, if the curvature of the provisional center line PCL in the vicinity of the host vehicle 11 is greater than the first threshold value Th1, a correction to the provisional center line PCL is carried out.

Upon receiving a correction instruction from the first determination unit 92, the first center line correction unit 95 recognizes the current position PO of the host vehicle 11 on the provisional center line PCL. In addition, a virtual arc Ar about which the host vehicle 11 can turn is set from the current position P0, with a curvature that is smaller than the first threshold value Th1 (a state in which the travel behavior is stabilized). The virtual arc Ar may have a constant size at all times, or alternatively, the size of the circle may change according to the situation. For example, the virtual arc Ar may coincide with or be near to a curvature that the host vehicle 11 traveling on the curve has followed in the past.

Furthermore, the first center line correction unit 95 causes the virtual arc Ar to be continuous with a virtual straight line SL1, which forms a tangent line of the virtual arc Ar at a predetermined point P1 (for example, a position advanced by 90° in the circumferential direction) through which the virtual arc Ar extends. For example, the virtual straight line SL1 may be set substantially parallel to the provisional center line PCL, at a position distanced somewhat from the vicinity of the host vehicle 11.

More specifically, the first center line correction unit 95 corrects the provisional center line PCL from the current position P0 of the host vehicle 11 into a first corrected center line CL_{cl}, in which the virtual arc Ar and the virtual straight line SL1 are continuous, at a location in front in the direction of travel of the host vehicle 11. Owing to this feature, the route information of the local environment map information Iem can be secured, and thereafter, it is possible to carry out generation of some sort of trajectory in the long-term trajectory generating unit 71, the medium-term trajectory generating unit 72, and the short-term trajectory generating unit 73. As a result, the vehicle control device 10 can avoid a sudden control stoppage during automatic driving.

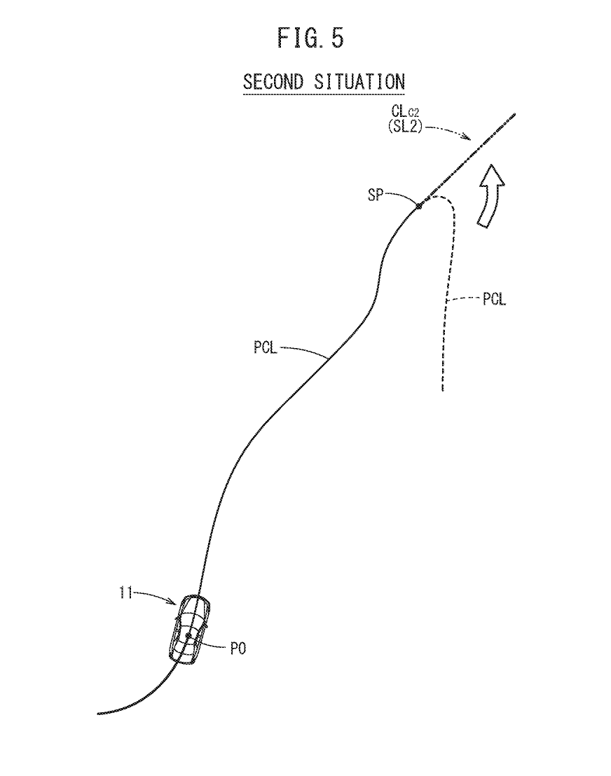

On the other hand, the second situation, as shown in FIG. 5, is a case in which a portion of the provisional center line PCL is generated by being rendered with a large change in curvature at a distance separated away from the host vehicle 11. More specifically, the vehicle control device 10 detects the surrounding environment with the external environment sensors 14 such as the cameras 33 or the like, however, concerning the detection information, which is detected at a distance separated away from the host vehicle 11, the detection accuracy thereof cannot necessarily be considered to be high. Further, there is also a possibility that the external environment recognition unit 52 may calculate as the left and right recognition lines a travel path that cannot be viewed completely from the cameras 33 or is unclear. Stated otherwise, the local environment map generating unit 54 cannot accurately determine whether or not the calculated provisional center line PCL actually coincides with the travel path shape.

Therefore, concerning the provisional center line PCL, the second determination unit 93 determines whether or not a large change in curvature exists therein at a position separated away from the host vehicle 11 by a predetermined distance or more, and in the case that a large change in curvature is detected or determined to be present, the second determination unit 93 causes a correction of the provisional center line PCL to be made by the second center line correction unit 96. More specifically, the second determination unit 93 stores in the threshold value storage unit 97 a second threshold value Th2 (separation threshold value) for the purpose of determining the change in curvature. The second threshold value Th2 is information concerning a rate of change of the curvature, which is obtained by differentiating the curvature. Further, concerning the curvature of the provisional center line PCL, the second threshold value Th2 distinguishes between a continuous change in which the rate of change of the curvature is small, and a discontinuous change in which the rate of change of the curvature is large. Moreover, instead of making a determination on the basis of the rate of change of the curvature, the second determination unit 93 may determine a magnitude of the curvature of the provisional center line PCL by a second threshold value Th2 that indicates the curvature of the travel path shape.

In addition, the second determination unit 93 reads out the second threshold value Th2, and determines whether or not a change in the curvature of the provisional center line PCL, which is separated by a predetermined distance or more (outside of the vicinity of the host vehicle 11, for example, 5 m or more) from the current position P0 of the host vehicle 11, is greater than the second threshold value Th2. If the change in curvature of the provisional center line PCL is less than or equal to the second threshold value Th2, since there is no problem even if the host vehicle 11 turns along such a curvature, no correction to the provisional center line PCL is considered necessary. Conversely, if the change in curvature of the provisional center line PCL is greater than the second threshold value Th2, a correction to the provisional center line PCL is carried out.

Upon receiving a correction instruction from the second determination unit 93, the second center line correction unit 96 sets a starting point SP at which a curve starts at a location where the change in curvature is large, and renders a virtual straight line SL2 that causes the host vehicle 11 to travel linearly from the starting point SP. The virtual straight line SL2 is preferably set on the provisional center line PCL as a tangent line at the starting point SP. Consequently, the second center line correction unit 96 is capable of generating a second corrected center line CL_{c2} which is continuous naturally with respect to the provisional center line PCL. Stated otherwise, also in relation to the second corrected center line CL_{c2}, since the route information of the local environment map information Iem is secured, it is possible to carry out generation of some sort of trajectory.

In the foregoing manner, the center line correction unit 90 determines the presence or absence of the first and second situations in the provisional center line PCL, and carries out an appropriate correction to the provisional center line PCL, whereby one of the provisional center line PCL, the first corrected center line CL_{cl}, or the second corrected center line CL_{c2} is output as the center line CL. Consequently, during traveling of the host vehicle 11, the local environment map generating unit 54 can provide local environment map information Iem that does not fall into a condition of control stoppage.

The provisional center line generating unit 80 is configured to impart a certain degree of reliability to the generated provisional center line PCL, and the second determination unit 93, together with determining the change in curvature of the provisional center line PCL, may determine based on the degree of reliability whether to carry out or not to carry out the correction. For example, the degree of reliability is given in the form of information concerning the detection accuracy when the travel path regulating objects 200 are extracted by the external environment recognition unit 52, and the degree of reliability is provided to the local environment map generating unit 54. Further, the degree of reliability may be expressed and set as a numerical degree within a range from a lowest value of 0 to a highest value of 1.

For example, the external environment recognition unit 52 performs various processes (comparison of image information from the plurality of cameras, comparison of relative amounts of information of objects in the image information, comparison with past image information, evaluation of the host vehicle state, evaluation of sharpness of the extracted objects, evaluation of brightness, evaluation of lightness and darkness, evaluation of the amount of image correction, detection of failure or degradation, detection of the state of communications, etc.) with respect to the detected information from the external environment sensors 14. Consequently, the external environment recognition unit 52 identifies road conditions (distance from the host vehicle 11 to the objects, good or bad condition of white lines and stop lines, quality of visibility by other vehicles and pedestrians), conditions of the external environment (the weather, direction of incidence of sunlight, ambient brightness, etc.), and conditions of the devices (whether lenses of the cameras 33 are good or bad, whether the communication state is good or bad, the presence or absence of failure or deterioration of the cameras 33, etc.), and then sets the degree of reliability.

Based on the degree of reliability, the second determination unit 93 can determine whether or not the received provisional center line PCL coincides with the actual travel path. Stated otherwise, if the degree of reliability is low, since this can be interpreted as implying that the provisional center line PCL (travel path shape) is unclear or cannot be viewed completely, a correction to the provisional center line PCL is determined to be necessary. For example, the second center line correction unit 96 recognizes a location thereof with high reliability and a location thereof with low reliability, and carries out a process to replace the low reliability location with the virtual strait line SL2 from a boundary portion of the provisional center line PCL where the degree of reliability is high. Consequently, the vehicle control device 10 can continue the control in a satisfactory manner. On the other hand, if the degree of reliability is high, since this can be interpreted as implying that the provisional center line PCL is correct, the second determination unit 93 determines that the provisional center line PCL should not be corrected, even if the curvature of the provisional center line PCL is large. Consequently, the vehicle control device 10 can carry out a travel control that matches with the actual travel path.

Returning to FIG. 2, on the basis of the center line CL calculated by the center line correction unit 90, the left/right boundary line generating unit 100 of the local environment map generating unit 54 generates the left and right boundary lines LB, RB of the travel path. In this case, the left/right boundary line generating unit 100 calculates lines normal to the center line CL for each of the coordinate points CP of the received center line CL. Since the normal lines extend in directions orthogonal to the tangent line for each of the coordinate points CP, the normal lines can easily be calculated. In addition, from the fact that the center line CL exists at an intermediate position between the left and right boundary lines LB, RB in the first place, the respective two points, each lying on the normal lines and having a distance from the center line CL that is one half of the lane width, are taken as coordinate points CP of the left and right boundary lines LB, RB. The lane width is calculated as an interval between the left and right recognition lines, which are included in the external environment recognition information Ipr. Consequently, pairs of coordinate points CP with the center line CL disposed at a center position therebetween are sequentially obtained, and a sequence composed of respective pairs of points at which the coordinate points CP are arranged can be set as the left and right boundary lines LB, RB.

When the left and right boundary lines LB, RB are generated, the local environment map generating unit 54 carries out processing by the event setting unit 110, whereby the event information I is set with respect to the calculated center line CL or the left and right boundary lines LB, RB, or alternatively to an ideal travel route (not shown) taking into consideration the traveling efficiency of the host vehicle 11 based on the left and right boundary lines LB, RB. Below, with reference to FIGS. 6A and 6B, a representative case will be described in which the event information I is imparted to the center line CL.

In this instance, the event information I which is to be imparted to the center line CL and the left and right boundary lines LB, RB is information which is provided on the travel path, and which requests that changes be made to the vehicle velocity of the host vehicle 11 when the host vehicle 11 travels on the travel path. Specific examples thereof include objects (stop lines, traffic signal stop lines, railroad crossings, etc.) that cause the host vehicle 11 to stop, and objects (speed signs, road signs, etc.) that cause the host vehicle 11 to accelerate or decelerate. Such features are applicable to static information on the travel path, in which changes do not occur thereto within a short time period.

Moreover, in the local environment map information Iem, dynamic information such as traffic participants (for example, other vehicles and pedestrians), obstacles, and the like are not added or imparted to the center line CL as event information. Such dynamic information is superimposed in a displaceable manner on the center line CL and the left and right boundary lines LB, RB as a layer (upper layer) that is separate from the center line CL and the left and right boundary lines LB, RB.

The event setting unit 110 specifies the positions of event objects that are included within the external environment recognition results Ip, and sets the event information I on the center line CL. Moreover, concerning the event objects, in addition to extracting such objects from the detection information of the external environment sensors 14, the external environment recognition unit 52 may extract such objects from map information of the navigation device 16 or from communications information of the communications device 20 or the like, and thereby generate the external environment recognition results Ip. Owing to this feature, the setting accuracy of the event information I is further enhanced. In the case that a plurality of event objects are recognized, the respective items of event information I are set, so that the events are performed sequentially along the center line CL based on the respective positions thereof.

For example, as shown in FIG. 6A, two items of event information I1 and I2 exist, in which the straight line distance d1, d2 thereof from the current position P0 of the host vehicle 11 is longer in the event information I1 than in the event information I2. Therefore, if one were to simply recognize the position of each item of the event information I1, I2, traveling of the host vehicle 11 would be controlled with priority placed on the event information I2 that is located closer to the host vehicle 11.

However, the generated center line CL is generated in such a manner so as to extend toward the event information I1 and fold back in an arcuate shape. In this case, the event setting unit 110 sets each of the event coordinate points ICP so that the host vehicle 11 passes through the events in order of the event information I1 followed by the event information I2. Stated otherwise, the event setting unit 110 sets the event information I with respect to the center line CL without concern as to the straight line distances d1, d2 from the host vehicle 11, whereby the order in which the events occur to the host vehicle 11 can be placed correctly on the center line CL.

Further, when the event information I is set in the form of a sequence of points on the center line CL, as shown in FIG. 6B, in the case that the position of the event information I is specified between two of the coordinate points CP, the event coordinate point ICP is set between these two coordinate points CP. Consequently, for example, it is possible to accurately set the position of a stop line or the like, which is an event that causes the host vehicle 11 to stop. Accordingly, the vehicle control device 10 is capable of performing a control to stop the host vehicle 11 sufficiently close to the event coordinate point ICP.

### [Process Flow of Local Environment Map Generating Unit 54]

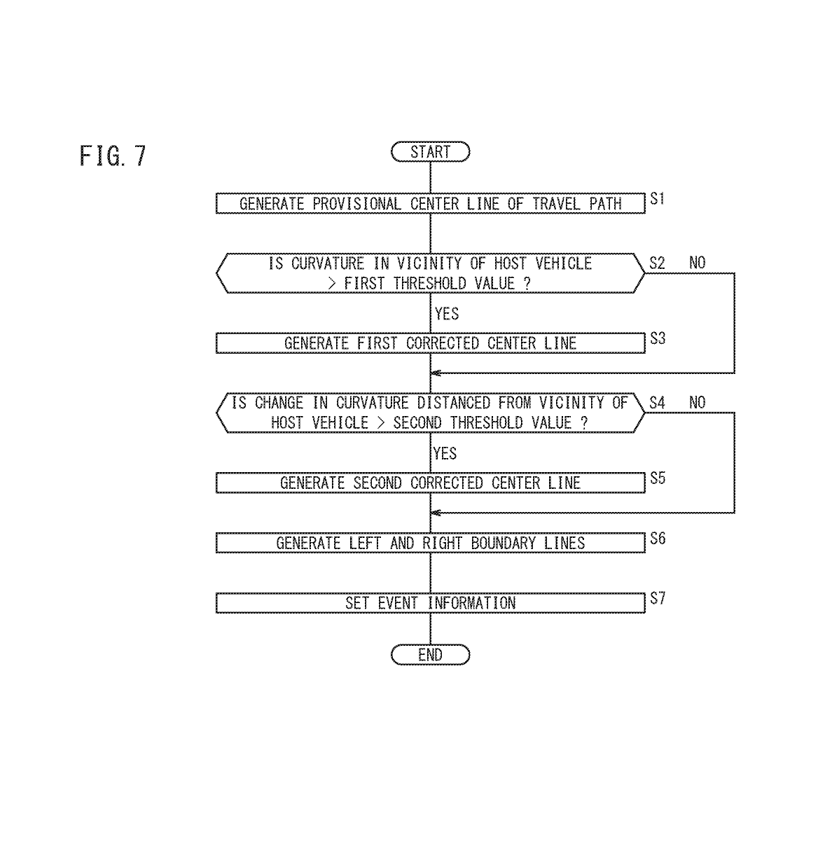

The vehicle control device 10 according to the present embodiment is configured basically in the manner described above. Below, operations and effects of the vehicle control device 10 will be described together with the process flow shown in FIG. 7, which takes place in the local environment map generating unit 54.

The vehicle control device 10 executes an automatic driving control during traveling of the host vehicle 11, on the basis of an instruction from the driver (an ON operation of the automatic driving switch 22 or the like). During the automatic driving control, the surrounding environment of the host vehicle 11 is detected by the external environment sensors 14, the navigation device 16, the communications device 20, etc., whereby the external environment recognition unit 52 recognizes the surrounding environment of the host vehicle 11. At this time, the left/right recognition line generating unit 52a of the external environment recognition unit 52 generates the left and right recognition lines on the basis of the travel path regulating objects 200 of the travel path, which were extracted from the detection information of the external environment sensors 14. In addition, under the direction of the integrated control unit 70, the recognition result receiving unit 53 transmits the external environment recognition information Ipr including the left and right recognition lines.

When the external environment recognition information Ipr and the host vehicle state information Ivh are transmitted together with the operation command Ab by the integrated control unit 70, the local environment map generating unit 54 initiates generation of the center line CL as well as the left and right boundary lines LB, RB. At this time, at first, the provisional center line generating unit 80 generates the provisional center line PCL (step S1) by performing a polynomial approximation using the left and right recognition lines contained within the external environment recognition information Ipr, and outputs the provisional center line PCL to the center line correction unit 90.

Next, the first determination unit 92 of the center line correction unit 90 determines whether or not the curvature of the provisional center line PCL in the vicinity of the host vehicle 11 is greater than the first threshold value Th1 (step S2). In addition, if the curvature of the provisional center line PCL is greater than the first threshold value Th1, the process proceeds to step S3, whereas if the curvature of the provisional center line PCL is less than or equal to the first threshold value Th1, the process skips over step S3 and proceeds to step S4.

In step S3, the first center line correction unit 95 generates the first corrected center line CL_{cl}, by connecting the curve in which the virtual arc Ar and the virtual straight line SL1 are continuous with respect to the current position P0 of the host vehicle 11 on the provisional center line PCL. Owing thereto, in the vicinity of the host vehicle 11, a correction can be made to the center line CL on which the host vehicle 11 is capable of turning.

Further, the second determination unit 93 of the center line correction unit 90 determines whether or not a change in the curvature of the provisional center line PCL from the vicinity of the host vehicle 11 is greater than the second threshold value Th2 (step S4). In addition, if the change in curvature of the provisional center line PCL is greater than the second threshold value Th2, the process proceeds to step S5, whereas if the change in curvature of the provisional center line PCL is less than or equal to the second threshold value Th2, the process skips over step S5 and proceeds to step S6.

In step S5, the second center line correction unit 96 generates the second corrected center line CL_{c2}, by connecting the linearly continuous virtual straight line SL2 with respect to the starting point SP at the location where the change in curvature of the provisional center line PCL becomes large. Owing thereto, it is possible to make a correction to the center line CL, in which generation of a route in which the traveling behavior of the host vehicle 11 is not stabilized is avoided, even if the travel path regulating objects 200 are distant and the travel path shape is too unclear to be adequately recognized. Moreover, after the first corrected center line CL_{cl} is calculated, the correction unit 94 may proceed directly to step S6 without performing the determination by the second determination unit 93 or the correction by the second center line correction unit 96 (refer to the dotted line in FIG. 2).

In addition, in step S6, on the basis of the center line CL that is output from the center line correction unit 90, the left/right boundary line generating unit 100 generates the left and right boundary lines LB, RB. Lastly, the event setting unit 110 sets the event information on the generated center line CL (or the left and right boundary lines LB, RB) (step S7). In accordance therewith, the local environment map generating unit 54 transmits to the integrated control unit 70 the local environment map information Iem, which includes the center line CL and the left and right boundary lines LB, RB having the event information I therein.

As described above, the vehicle control device 10 according to the present embodiment can suitably control the host vehicle 11 by the local environment map generating unit 54 correcting the curvature of the provisional center line PCL, in the case that the curvature of the provisional center line PCL is significantly large. More specifically, by means of the correction, the curvature of the provisional center line PCL, which was generated based on detection of the surrounding environment, is made to match with the traveling behavior of the host vehicle 11, and therefore, the map generating unit 54 is capable of providing a center line CL that suppresses a sudden change in the control content such as stopping the control of the host vehicle 11 or the like. Consequently, the vehicle control device 10 can continue the control of the host vehicle 11 based on the center line CL.

In this case, by the vehicle control device 10 generating the first corrected center line CL_{cl} in which the virtual arc Ar, which corresponds to the turning ability of the host vehicle 11, is connected to the provisional center line PCL, it is possible to control the host vehicle 11 so as to follow along the center line CL. Furthermore, in the vehicle control device 10, by making the virtual straight line SL1 continuous with the virtual arc Ar, it is possible to allow the host vehicle 11 to travel while avoiding turning in such a manner that the host vehicle 11 makes a U-turn. Further, the first determination unit 92 determines the curvature of the provisional center line PCL in the vicinity of the host vehicle 11, whereby the host vehicle 11 can immediately change to traveling along the first corrected center line CL_{cl}. In addition, assuming the vicinity of the host vehicle 11 lies within the range of the vehicle length or less, in the case that the provisional center line PCL is corrected, the vehicle control device 10 can form a route in which turning of the host vehicle 11 can be executed in a stable manner.

Alternatively, by linearly correcting a location within the provisional center line PCL that is distanced from the vicinity of the host vehicle 11 and where the change in curvature is significantly large, it is possible for the vehicle control device 10 to continue the control of the host vehicle 11 more reliably. Further, by the second determination unit 93 determining a change in the curvature of the provisional center line PCL that is more distant than the vicinity of the host vehicle 11, even if detection of the travel path by the external environment sensors 14 is unclear, it is possible to follow the shape along the second corrected center line CL_{c2}.

Furthermore, due to the event information I being set on the center line CL by the event setting unit 110, the vehicle control device 10 can easily implement a control corresponding to the event information I when the host vehicle 11 travels on the travel path. At this time, by setting the event coordinate point ICP between the plurality of coordinate points CP, it is possible to accurately reflect the position of the event information I on the center line CL. Accordingly, for example, in the case of event information I for which the host vehicle 11 is to stop, the vehicle control device 10 can cause the host vehicle 11 to stop accurately at the position of the event information I.

The present invention is not limited to the embodiment described above, and it is a matter of course that various modifications or additional configurations could be adopted therein without deviating from the essence and gist of the present invention. For example, a case can also be applied in which the vehicle control device 10 performs a driving assist that carries out only a speed control or carries out only a steering control, or a driving assist that provides guidance to the driver who manually drives the vehicle of the target vehicle speed and the target steering position from a monitor, a speaker, or the like as vehicle mounted devices. As an example, in such a driving assist, it is possible to provide guidance to the driver of an appropriate route by displaying the calculated center line CL on a monitor of the host vehicle 11.

What is claimed is:

1. A vehicle control device which is installed in a host vehicle and configured to be capable of implementing automatic driving or providing a driving assist, comprising:
an external environment sensor adapted to detect a surrounding environment of the host vehicle; and
a map generating unit adapted to generate a travel path shape of a travel path on which the host vehicle travels, based on detection information detected by the external environment sensor;
wherein the map generating unit includes:
a determination unit adapted to determine whether or not a curvature of the travel path shape or a change in the curvature is greater than a predetermined value; and
a correction unit adapted to correct the curvature of the travel path to be less than or equal to the predetermined value, in an event it is determined by the determination unit that the curvature of the travel path shape or the change in the curvature is greater than the predetermined value.

2. The vehicle control device according to claim 1, wherein the correction unit corrects the travel path shape into an arcuate route corresponding to a turning ability of the host vehicle.

3. The vehicle control device according to claim 2, wherein, in the correction of the travel path shape, the correction unit causes a tangent line of a predetermined point of the arcuate route to be continuous with the arcuate route.

4. The vehicle control device according to claim 2, wherein the determination unit determines whether or not the curvature of the travel path shape in the vicinity of the host vehicle is greater than a vicinity threshold value which serves as a limit value of the turning ability of the host vehicle.

5. The vehicle control device according to claim 4, wherein the vicinity of the host vehicle lies within a range extending from a current position to a vehicle length of the host vehicle or less.

6. The vehicle control device according to claim 1, wherein the correction unit linearly corrects the travel path shape of a location where the change in the curvature is large.

7. The vehicle control device according to claim 6, wherein the determination unit determines whether or not the change in the curvature of the travel path shape, which is more distant than the vicinity of the host vehicle, is greater than a separation threshold value.

8. The vehicle control device according to claim 7, wherein:
the determination unit, together with determining the change in the curvature of the travel path shape, also determines a degree of reliability of the detection information; and
in the case that the degree of reliability is less than or equal to a predetermined value, correction of the travel path shape is performed by the correction unit, whereas in the case that the degree of reliability is greater than the predetermined value, correction of the travel path shape is not performed by the correction unit.

9. The vehicle control device according to claim 1, wherein the map generating unit includes an event setting unit adapted to set event information that changes a vehicle velocity of the host vehicle, which is extracted from map information and/or the detection information, on the generated or corrected travel path shape.

10. The vehicle control device according to claim 9, wherein:
the travel path shape contains information of a sequence of points in which a plurality of coordinate points are arranged; and
the event setting unit sets a coordinate point of the event information among the plurality of coordinate points, in the event that a position of the extracted event information is located among the plurality of coordinate points.

11. The vehicle control device according to claim 1, wherein the travel path shape is calculated as a center line of the travel path.
